(19) United States
(12) Patent Application Publication
(10) Pub. No.: US 2009/0249904 A1
(43) Pub. Date: Oct. 8, 2009

(54) Linear Actuator

(76) Inventors: TUNG-HSIN CHEN, Taichung (TW); HSIN-AN CHIANG, Taichung (TW)

Correspondence Address: Dr. BANGER SHIA, 102 Lindencrest Ct., Sugar Land, TX, 77479-5201, US

(21) Appl. No.: 12/098,446

(22) Filed: Apr. 6, 2008

(51) Int. Cl. F16H 25/20

(52) U.S. Cl. 74/89.23

(57) ABSTRACT

A linear actuator comprises an outer tube, an intermediate tube and an inner tube which are polygonal in cross section. The outer tube is provided for the insertion of the intermediate tube and the inner tube, and the respective tubes are restricted with respect to one other. The outer tube is disposed with a push device having a screw and a nut that are screwed with each other and at least one tension adjusting device. At a top of a push pole is disposed a pulley pushing and supporting a pulling member whose two ends are respectively fixed between the inner tube and the outer tube, and another pulling member winding around a pulley is disposed between the intermediate tube and the inner tube. Thus, each pulling member can be pulled to change the tension so as to keep the stability.

### BACKGROUND OF THE INVENTION

1. Field of the Invention

The present invention relates to a linear actuator, and more particularly to a transmission device, which can be radially restricted but can perform a stable axial extending/retracting movement and adjust the prestress and tension between the respective tubes by using tension adjusting device.

2. Description of the Prior Art

The existing linear actuators have a quite wide range of use and are generally driven by motors to retract and extend other mechanisms.

Referring to FIGS. 1-2, a conventional linear actuator 90 disclosed in U.S. Pat. No. 6,880,416 is disposed with a three-segment telescopic structure consisting of three tubes 91, 92 and 93, in which is disposed a motor 94. The motor 94 is used to drive a screw assembly 95 which is disposed with three screws 96, 97 and 98. The three screws 96, 97 and 98 are connected to the respective telescopic tubes, 91, 92 and 93 of the linear actuator 90, respectively. The motor 94 drives the three screws 96, 97 and 98 to move in the axial direction, so that the respective telescopic tubes 91, 92 and 93 can be driven to retract and extend.

The above configuration and structure can retract and extend, but it still has the following disadvantages:

First, it is unable to adjust the prestress of the respective screws during the moving process of the respective screws: since the respective screws 96, 97, 98 push the respective telescopic tubes 91, 92, 93 of the linear actuator 90, respectively. Once they become loose, they are unable to be adjusted appropriately to produce difference prestress, so that it can't meet the requirement of adjustment.

Second, complicated structure and inconvenient to assemble: the three screws 96, 97 and 98 push the respective telescopic tubes 91, 92 and 93 of the linear actuator 90, respectively, the three-segment screw assembly complicates the linear actuator 90 structure and makes its assembly inconvenient.

Third, high cost: the respective telescopic tubes 91, 92 and 93 of the above linear actuator 90 are connected to three screws 96, 97 and 98, respectively, such a structure design increases the cost of manufacturing the linear actuator 90.

Additionally, referring to FIGS. 3-4, another conventional actuator 80 disclosed in EP. Pat. No. 0982018 comprises a circular three-segment telescopic structure including three tubes 81, 82 and 83, in which are disposed a motor 84 and a screw 85. The motor 84 and the screw 85 are disposed in the telescopic tube 81, and the motor 84 drives the screw 85 to rotate. The screw 85 drives a brace rod due to threaded connection, and the brace rod is disposed with a pulley 86 on the top thereof, thus causing an axial displacement. The pulley 86 serves as a movable pulley to drive another telescopic tube 83 to move in the axial direction by cooperating with a chain, in such a manner that the circular telescopic tubes 81, 82 and 83 are driven to extend and retract.

Though the above configuration and structure is extendable and retractable, it still has the following disadvantages:

First, it is likely to cause internal damage: the three telescopic tubes 81, 82 and 83 are designed in the form of a circular tube, the three telescopic tubes 81, 82 and 83 have no restricting structure, such a design is likely to cause damage to the internal structure due to the radial rotation and friction while the motor 84 drives the screw 85 to rotate.

Second, linkage is likely to cause mutual interference: with the displacement of the pulley 86 at the top of the brace rod, the screw 85 utilizes the chain to drive the telescopic tube 83 to successively link with the telescopic tube 82 and so on, furthermore, between the bottom of the telescopic tube 82 and the screw 85 is disposed a restricting structure which causes the unnecessary interference during the pulling process of the restricting structure and the chain, thus affecting the entire telescopic operation.

Though the above configuration and structure is extendable and retractable, it still has the following disadvantages:

First, it is likely to cause internal damage: the movement of the telescopic tubes 81, 82 and 83 is caused by the inner screw 85, this design still has the same disadvantages as the prior invention, the engagement of the respective tubes will become loose and loose, so that it can't meet the requirement of adjustment.

Second, it is likely to cause the structure damage during rotation: the respective tubes are designed in the form of a circular tube, the three telescopic tubes 81, 82 and 83 have no restricting structure, such a design is likely to cause damage to the internal structure due to the axial rotation and friction while the motor 84 drives the screw 85 to rotate;

Third, linkage is likely to cause mutual interference: with the displacement of the pulley 86 at the top of the brace rod, the screw 85 utilizes the chain to drive the telescopic tube 83 to successively link with the telescopic tube 82 and so on, furthermore, between the bottom of the telescopic tube 82 and the screw 85 is disposed a restricting structure which causes the unnecessary interference during the pulling process of the restricting structure and the chain, thus affecting the entire telescopic operation.

The present invention has arisen to mitigate and/or obviate the afore-described disadvantages.

### SUMMARY OF THE INVENTION

The primary objective of the present invention is to provide a liner actuator which comprises a polygonal outer tube provided for insertion of an intermediate tube and an inner tube, the outer tube is disposed with a push device and at least one tension adjusting device, the push device includes a screw and a nut that are screwed with each other and restrictively disposed in the intermediate tube, and one end of the screw is disposed in the outer tube. Two pulling members are respectively disposed between the inner tube and the outer tube and between the inner tube and the intermediate tube, the respective pulling members can cooperate with the tension adjusting device to adjust the prestress of the two pulling members although there are adjustable prestress and tension between the respective tubes.

Through the cooperation of the nut and the intermediate tube, the unnecessary intervention caused by the axial movement of the respective tubes with the intermediate tube can be avoided. With the arrangement of the pulling members and the tension adjusting device, the respective tubes can perform a stable movement by the generation of the prestress of the respective tubes. By using the pulling member to adjust the clearance between the outer tube, the intermediate tube and the inner tube, the linear actuator can be radially restricted but can perform a stable axial extending/retracting movement and adjusting the clearance between the respective tubes.

### BRIEF DESCRIPTION OF THE DRAWINGS

FIG. 1 is a side view of a conventional linear actuator;

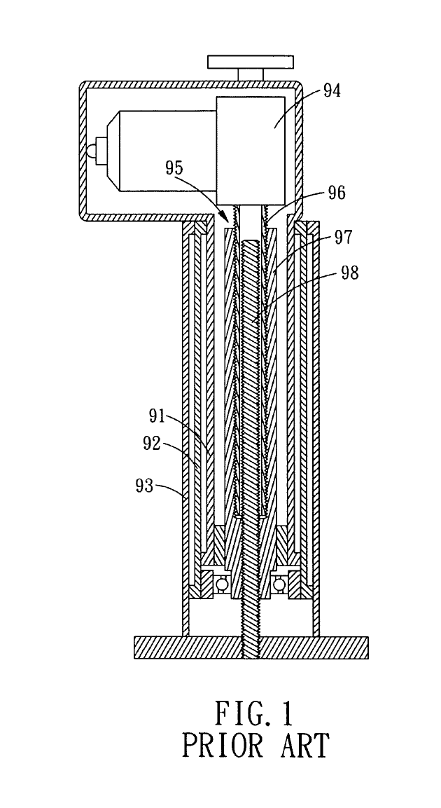

FIG. 2 is a side view showing that the conventional linear actuator is extended;

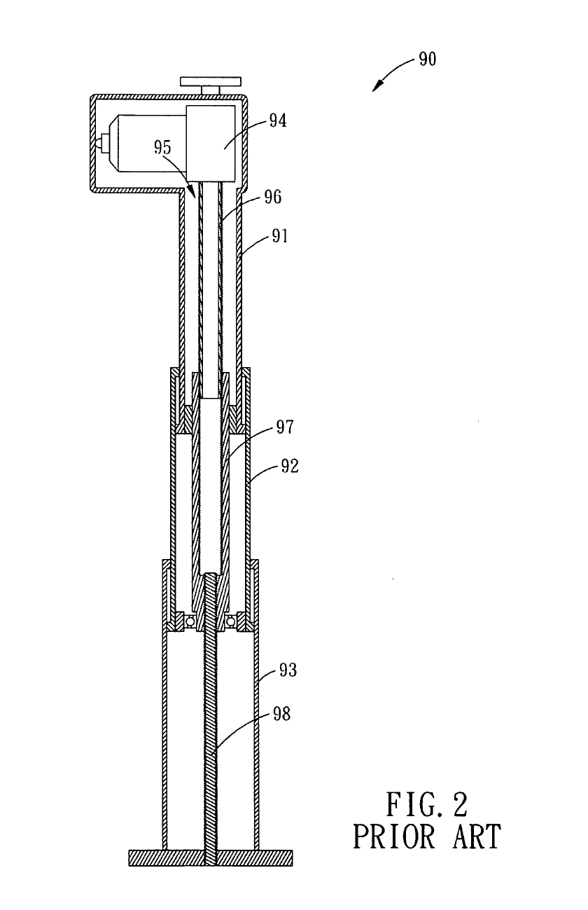

FIG. 3 is a side view of another conventional linear actuator;

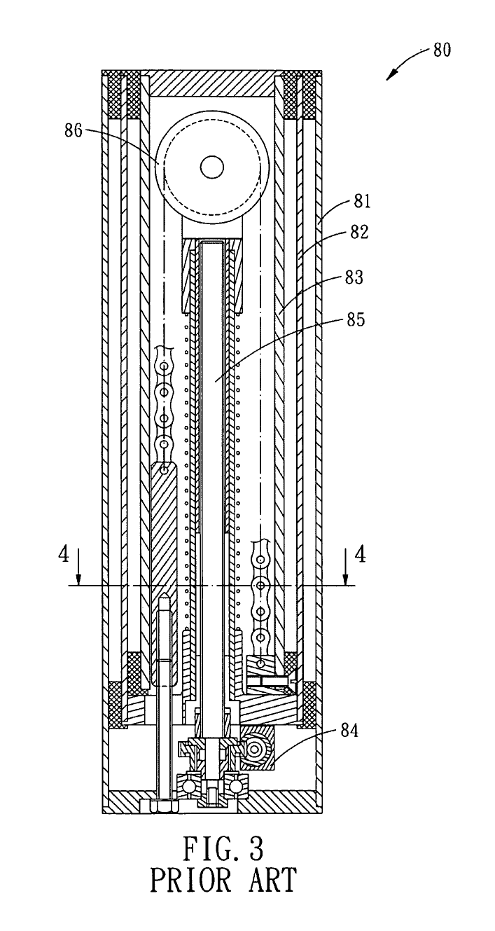

FIG. 4 is a top view of another conventional linear actuator;

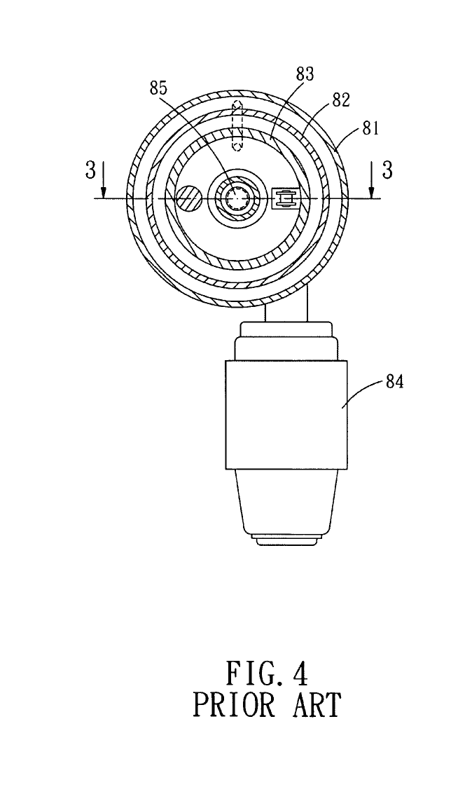

FIG. 5 is a top view of a linear actuator in accordance with the present invention;

FIG. 6 is a partial exploded view of the linear actuator in accordance with the present invention;

FIG. 7 is a cross sectional view showing the unextended state of the linear actuator in FIG. 5 in accordance with the present invention;

FIG. 8 is a cross sectional view showing that the extending action of the actuator in FIG. 7 in accordance with the present invention; and

FIG. 9 is a cross sectional view showing that the linear actuator in FIG. 8 is extended to the highest position in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

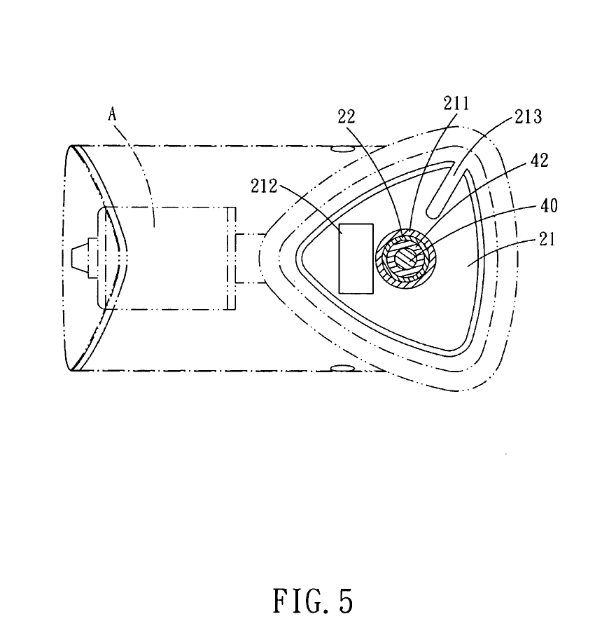

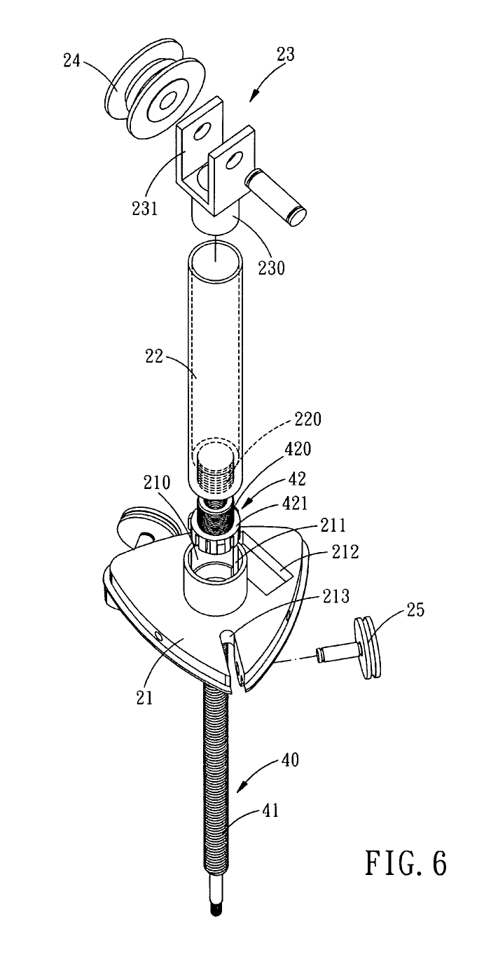

Referring to FIGS. 5-7, a linear actuator in accordance with the present invention comprises a polygonal outer tube 10 which is provided for the insertion of an intermediate tube 20 and an inner tube 30 that are shaped the same as the outer tube 10. The polygonal configuration allows the outer tube 10, the intermediate tube 20 and the inner tube 30 to extend and retract with respect to one other in the axial direction without moving relative to one another in the radial direction, thus keeping the stability of the retracting/extending movement of the respective tubes. The respective tubes 10, 20 and 30 can be in the form of a triangle, quadrangle or pentagon in cross section. A push device 40 which can push the intermediate tube 20 to move in the axial direction and two tension adjusting devices 60A, 60B are disposed in the outer tube 10, and two pulling members 50A, 50B connected and controlled respectively by the two tension adjusting devices 60A, 60B are disposed between the respective tubes. Using the push device 40 to push the respective tubes 10, 20, 30 to move in the axial direction, the pulling members 50A, 50B can be pulled simultaneously to drive the inner tube 30 to move in the axial direction. Thus the tension adjusting devices 60A, 60B can use the pulling members 50A, 50B to adjust the clearance between the outer tube 10, the intermediate tube 20 and the inner tube 30. By such arrangements, the linear actuator allows the respective tubes to axially extend and retract relative to one another with the least interference while preventing them from moving relative to one another in radial direction, thus the linear actuator can be radially restricted but can perform a stable axial extending/retracting movement and adjusting the clearance between the respective tubes.

The outer tube 10 is polygonal in cross section and is disposed with the push device 40 and the two tension adjusting devices 60A, 60B at one end thereof.

The intermediate tube 20 is polygonal in cross section and is disposed with a triangular connecting plate 21 at the end opposite to the outer tube 10, the connecting plate 21 is centrally disposed with a receiving portion 210 in the form of a round hole. The receiving portion 210 is provided for engaging with the push device 40 and a hollow cylinder-shaped push pole 22. In the inner surface of the receiving portion 210 is equidistantly disposed a plurality of elongated guiding grooves 211 extending along the extending/retracting direction of the respective tubes. The guiding grooves 211 are provided for engaging with and restricting the push device 40. The push pole 22 is disposed with an inner threaded portion 220 in one end thereof opposite to the connecting plate 21. The inner threaded portion 220 is screwed on a corresponding member in the push device 40, the other end of the push pole 22 is provided for the insertion of a three-dimensional Y-shaped pivot body 23 which is disposed with a cylindrical inserting portion 230 at one end thereof. The inserting portion 230 is inserted into one end of the push pole 22, and the other end of the pivot body 23 is a U-shaped pivot portion 231 for pivotally coupling with a first pulley 24 around which the pulling member 50A winds.

The triangular connecting plate 21 is disposed in one end thereof with a rectangular hollow portion 212 for the insertion of the pulling member 50A. The other end of the connecting plate is disposed with a slot 213. The open end of the slot 213 is pivotally coupled with a second pulley 25 around which another pulling member 50B winds.

The inner tube 30 is polygonal in cross section and is inserted into the intermediate tube 20, one end of the inner tube 30 is provided for fixing the two pulling members 50A, 50B.

The push device 40 includes a screw 41 and a nut 42 that are screwed with each other. One end of the screw 41 is pivotally coupled in the outer tube 10 and is to be driven by a motor. The nut 42 includes an outer threaded portion 420 to be screwed with the inner threaded portion 220 of the push pole 22. After the nut 42 is screwed, it will be engaged into the receiving portion 210 of the connecting plate 21. The periphery of the nut 42 is equidistantly disposed with a plurality of guiding portions 421 which extend along the extending/retracting direction of the respective tubes and are to be restricted in the guiding grooves 211 of the connecting plate 21 respectively.

The pulling member 50A winds around the first pulley 24 of the push pole 22. One end of the pulling member 50A is fixed to the tension adjusting device 60A of the outer tube 10 while the other end is fixed at the bottom of the inner tube 30.

In addition, the pulling member 50B winds around the second pulley 25 of the connecting plate 21, one end of the pulling member 50B is fixed to the tension adjusting device 60B of the outer tube 10 while the other end is fixed to one end of the inner tube 30.

The pulling members 50A, 50B can be selected from the group consisting of a belt, a chain and a steel cable.

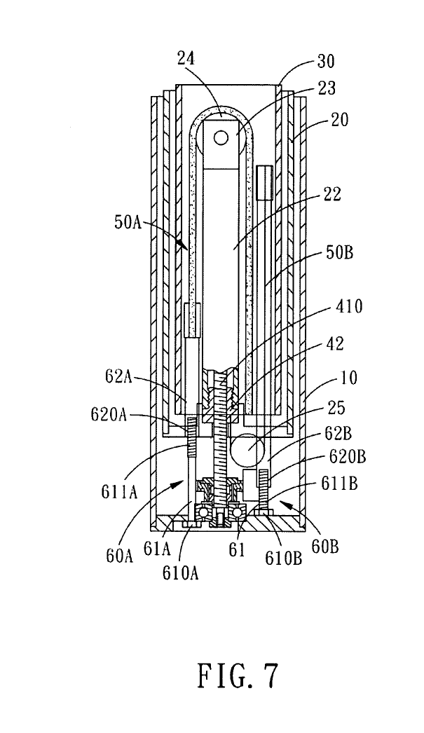

Referring to FIG. 7, the tension adjusting device 60A includes an adjusting screw 61A and a screw pole 62A, and the tension adjusting device 60B includes an adjusting screw 61B and a screw pole 62B. Each of the adjusting screws 61A, 61B is respectively disposed with an adjusting portion 610A, 610B pivotally penetrating the bottom of the outer tube 10 and a threaded portion 611A, 611B to be screwed with a threaded hole 620A, 620B in one end of the screw poles 62A, 62B. The pulling member 50A is fixed to the other end of the screw pole 62A of the tension adjusting device 60A, and the pulling member 50B is fixed to the other end of the screw pole 62B of the tension adjusting device 60B.

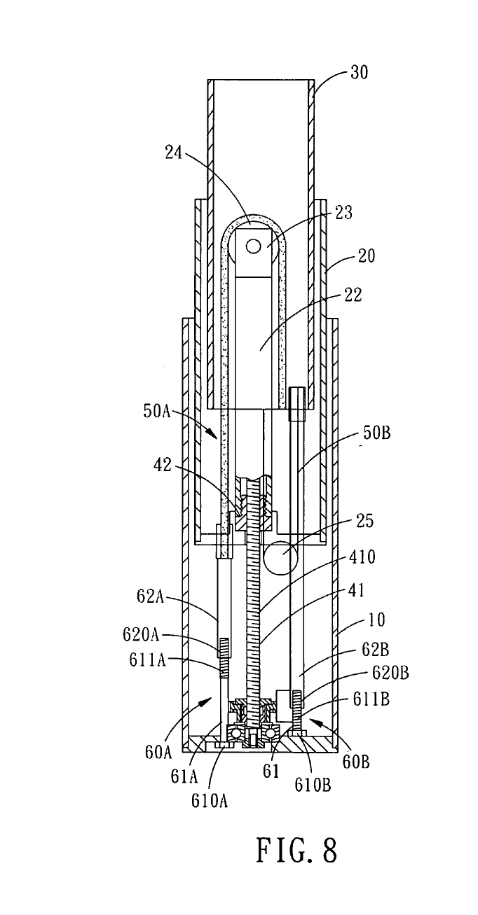

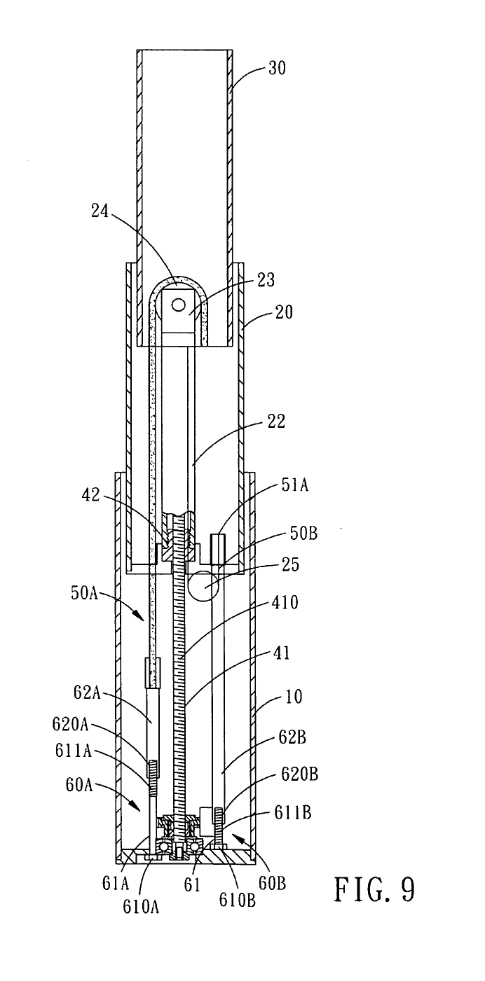

Additionally, FIGS. 7-9 show the movement of the present invention, referring to FIG. 9, wherein the motor drives the screw 41 of the push device 40 to enable the nut 42 of the screw 41 to push the push pole 22 of the intermediate tube 20 to move up and down in the axial direction, and the second pulley 25 of the connecting plate 21 of the intermediate tube 20 and the first pulley 24 of the push pole 22 enable the pulling member 50A, 50B to cooperate with the inner tube 30 to move up and down in the axial direction. In addition, the tension adjusting devices 60A, 60B can adjust the clearance between the outer tube 10, the intermediate tube 20 and the inner tube 30 by cooperating with the pulling members 50A, 50B, the linear actuator can be radially restricted but can perform a stable axial extending/retracting movement and adjusting the clearance between the respective tubes.

With the above structures, the present invention can offer the following functions:

1. stabilizing and restricting retracting/extending movement: the outer tube 10, intermediate tube 20 and the inner tube 30 are all the polygonal tube-shaped structures, and the outer tube 10 is provided for the insertion of the intermediate tube 20 and the inner tube 30, by such a polygonal tube-shaped structure design, the outer tube 10, the intermediate tube 20 and the inner tube 3 can be radially restricted but can perform a stable axial extending/retracting movement.

2. convenience of production, check and assembly: the arrangement of the nut 42 and the push pole 22 of the intermediate tube 20 provides convenience of production, check and assembly, which also reduces the interference of the respective tubes, lowers the noise and smoothes the extending and retracting movement during the extension and retraction of the outer tube 10, the intermediate tube 20 and the inner tube 30.

3. high safety: the inner tube 30 can be prevented from dropping down to impact the intermediate tube 20 due to damage of one of the pulling member 50A or the pulling member 50B, thus achieve the high safety.

4. adjusting the clearance between the respective tubes: the tension adjusting devices 60A, 60B can adjust the clearance between the outer tube 10, the intermediate tube 20 and the inner tube 30 by the pulling members 50A, 50B so as to strain the condition of the telescope action of the linear actuator.

While we have shown and described various embodiments in accordance with the present invention, it is clear to those skilled in the art that further embodiments may be made without departing from the scope of the present invention.

What is claimed is:

1. A linear actuator comprising:
an outer tube being polygonal in cross section;
an intermediate tube being polygonal in cross section and inserted into the outer tube, and the intermediate tube being disposed with a connecting plate at a bottom thereof, the connecting plate being centrally disposed with a receiving portion for insertion of a push pole and being pivotally coupled with a pulley;
an inner tube being a polygonal in cross section and inserted into the intermediate tube;
a push device including a screw and a nut that are screwed with each other, one end of the screw being pivotally coupled to a bottom of the outer tube, and the nut being restricted in the receiving portion of the connecting plate of the intermediate tube and being engaged with the push pole;
two pulling members both ends of each of which being respectively disposed between the inner tube and the outer tube, one of the two pulling members winding around a pulley of the push pole, the other one of the two pulling members winding around the pulley of the connecting plate; and
at least two tension adjusting devices being disposed at junctions of the two pulling members and the outer tube, and each tension adjusting device being disposed at an inner bottom of the outer tube and fixed to one end of each of two pulling members, respectively, and each tension adjusting device including a pivotally disposed adjusting screw and a screw pole being in an axial direction, one end of each screw pole being screwed with the adjusting screws, and the other end of each screw being fixed to the two pulling members, respectively.

2. The linear actuator as claimed in claim 1, wherein the screw of the push device and the adjusting screws of the tension adjusting devices are disposed at the inner bottom of the outer tube.

3. The linear actuator as claimed in claim 1, wherein the receiving portion of the connecting plate is equidistantly disposed with at least one guiding groove extending along an extending/retracting direction of the respective tubes, the nut is disposed with at least one guiding portion which extends along an extending/retracting direction of the respective tubes and is to be restricted in the guiding groove of the connecting plate.

4. The linear actuator as claimed in claim 1, wherein the pulling member is selected from the group consisting of a belt, a chain and a steel cable.

5. The linear actuator as claimed in claim 1, wherein each adjusting screw of the tension adjusting devices is disposed with an adjusting portion and a threaded portion, the adjusting portion is pivotally disposed at the inner bottom of the outer tube, and the threaded portion is screwed with a threaded hole of the screw pole.

6. The linear actuator as claimed in claim 1, wherein the outer tube, the intermediate tube and the inner tube are triangular tubes.

7. The linear actuator as claimed in claim 1, wherein the outer tube, the intermediate tube and the inner tube are tetragonal tubes.

8. The linear actuator as claimed in claim 1, wherein the outer tube, the intermediate tube and the inner tube are quinquangular tubes.
